(19) United States
(12) Patent Application Publication
(10) Pub. No.: US 2022/0005381 A1
(43) Pub. Date: Jan. 6, 2022

(54) ANTI-MICROBIAL SECURITY SEALS

(71) Applicant: Cambridge Security Seals LLC, Pomona, NY (US)

(72) Inventors: Elisha Tropper, Scarsdale, NY (US); Raymond Townsend, Johnstown, CO (US)

(21) Appl. No.: 17/354,087

(22) Filed: Jun. 22, 2021

Related U.S. Application Data
(60) Provisional application No. 63/048,475, filed on Jul. 6, 2020.

(51) Int. Cl. G09F 3/03; B29C 45/00; A01N 59/20

(52) U.S. Cl. CPC G09F 3/0305; B29C 45/0001; B29K 2023/10; B29K 2023/06; A01N 59/20

(57) ABSTRACT

Apparatus and methods for polymeric security seal parts having anti-microbial properties and for the production of such seal parts, are provided. The seal parts may be produced by molding a formulation that includes a polymeric base resin and also a quantity of microbicidal metal ion. The molding may be injection molding. The formulation may contain sufficient metal ion for molded seals to have microbicidal exterior surfaces, without compromising moldability of the formulation. The formulation may contain sufficient metal ion for molded seals to have microbicidal properties throughout the interior of their structures, without compromising the moldability of the formulation. The anti-microbial polymeric security seal parts may be marked with function-descriptive and/or identifying surface markings. The identifying surface markings may be unique to individual seal parts. The anti-microbial polymeric security seal parts may facilitate secure tamper-evident anti-microbial sealing of enclosures.

### CROSS-REFERENCE TO OTHER APPLICATIONS

This application is a nonprovisional of U.S. Application No. 63/048,475, which was filed on Jul. 6, 2020, and is hereby incorporated by reference herein in its entirety.

### FIELD OF TECHNOLOGY

Aspects of the disclosure relate to production of polymeric security seal parts having anti-microbial properties.

### BACKGROUND OF THE DISCLOSURE

Seals have been used throughout history to assure authenticity and/or safety of sealed items. With the advent of polymer technology, seals completely or partly made of plastic have proliferated, being available in many configurations and being utilized in numerous applications.

Some polymeric seal parts may constitute one-piece plastic seals that, depending on their structure, function similar to zip ties, snap-top bands, padlocks or other closable monolithic configurations. Such seals may typically be threaded through and/or around usually dedicated closure components of enclosures (e.g., packages, cases, truck compartments, storage carts, shipping containers) that have been closed; the seals may then be irreversibly closed on themselves, such that the enclosures cannot be opened without irreversibly breaking the seal. With unique and easily traceable identification of each seal part, typically via some form of printing or imprinting, a uniquely identified tie, band, padlock or the like thus provides for trackable and auditable tamper-evident sealing of the enclosures.

Some polymeric seal parts may function in conjunction with seal parts made of other materials, such as metal, to provide a high security closure. In such high security seals, a first end of a polymeric seal part may provide a tight tamper-evident connection to an end with a locking chamber constructed of a more durable seal part such as a steel bolt; a second end of the polymeric seal part may provide a base or retainer for irreversibly docking the other end of the more durable part.

Applications in which seals are used to ensure authenticity and/or safety include: safety seals on inspected fire extinguishers; tamper-evident seals on airline catering and beverage carts; security seals on cargo containers, trucks and trailers, and merchandise cases; lot tracing and/or date-bearing freshness seals on wholesale food shipments; lot tracing, tamper-evident authenticity seals on containers or shipments of pharmaceuticals or medical supplies and equipment.

Mass production of polymeric seal parts may be conducted by automated equipment that allows only minimal contact with environmental microbes. However, the application of a seal to an enclosure, the shipment/transfer of the sealed enclosure, and the breaking of the seal to allow access to sealed items within the enclosure, usually entail hands-on manipulation. Such manipulation may expose the seal to environmental microbes that may be transferable from the seal to those handling the seal throughout the supply chain and, from them, to other destinations, including the items that had been sealed.

For many seal applications involving food, pharmaceuticals or other medical supplies, concern over microbial contamination may be acute. Even for more general seal applications, avoidance of transfer of potentially infectious microbes to the human body (face, eyes, nose, lips and other body areas) from work-surfaces such as seals may be strongly recommended.

Accordingly, it would be desirable to provide seals that have anti-microbial properties, preferably microbicidal properties, to minimize microbial transmission from usually often-handled seals. Additionally, since broken seals often remain attached to opened enclosures or lie on the floor or ground until being disposed of by hand, and thus provide freshly exposed seal surfaces to microbial contamination, it would also be desirable to have the agents of seal anti-microbial properties be present throughout the body of the seal.

It would be further desirable to provide systems and methods of production of anti-microbial seals.

### SUMMARY OF THE DISCLOSURE

A system for production of anti-microbial polymeric seal parts is provided. A quantity of microbicidal metal ion may be mixed with a polymer base resin to produce a moldable microbicidal formulation. The quantity of metal ion mixed with the base resin may be fixed or may be tuned for specific seal-applications. The quantity of metal ion mixed with the base resin may be such that, upon completion of mixing, the metal ion is present throughout the formulation in microbicidal concentration. The mixing may be conducted so that the metal ion is distributed substantially homogenously throughout the formulation. The formulation may be heated. The mixing may be conducted, entirely or at least partly, during the heating. The formulation may be plasticized. The formulation may be melted. The formulation may be processed in molding equipment such as injection molding equipment to produce seal parts of specific configurations. The seal parts so produced may be labeled with identifying symbols, such as unique bar codes, alphanumeric sequences, or customized logos or artwork, to provide for trackable, auditable, tamper-deterring, tamper-evident, and authenticating of shipments of enclosures sealed with the invention's polymeric anti-microbial security seal parts.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative set of seal parts of a type in accordance with principles of the invention, as they might appear after manufacture;

FIG. 2 shows a single seal part of the type shown in FIG. 1 as it might appear before being applied to an enclosure;

FIG. 2A shows a magnified detail of the single seal part shown in FIG. 2;

FIG. 2B shows another magnified detail of the single seal part shown in FIG. 2;

FIG. 3 shows a single seal part of the type shown in FIG. 1, looped on and through itself, as it might appear applied to an enclosure (the enclosure is not shown);

FIG. 4 shows an illustrative set of seal parts of a type in accordance with the principles of the invention, as they might appear after manufacture;

FIG. 5 shows a single seal part of the type shown in FIG. 4 as it might appear before being applied to an enclosure;

FIG. 6 shows a single seal part of the type shown in FIG. 4, looped on and snapped into itself, as it might appear applied to an enclosure (the enclosure is not shown);

FIG. 7 shows an illustrative seal part of a type in accordance with the principles of the invention, as it might appear before being applied to an enclosure;

FIG. 8 shows the seal part shown in FIG. 7, shut down on and into itself as it might appear applied to an enclosure (the enclosure is not shown);

FIG. 9 shows a seal part of the type shown in FIG. 1, looped on and through itself, as it might appear applied to an enclosure;

FIG. 10 shows seal parts of the type shown in FIG. 4, looped on and snapped into themselves, they might appear applied to an enclosure requiring several seals;

FIG. 11 shows a seal part of the type shown in FIG. 7, shut down on and into itself, as it might appear applied to an enclosure;

FIG. 12 shows, in schematic form, illustrative manufacturing equipment for production of seal parts in accordance with the principles of the invention;

FIG. 13 shows a flowchart of illustrative manufacturing steps for producing seal parts in accordance with the principles of the invention;

FIG. 14 shows a view of illustrative manufacturing equipment for production of seal parts in accordance with the principles of the invention;

FIG. 15 shows another view of the illustrative manufacturing equipment for production of the seal parts; and

FIG. 16 shows yet another view of the illustrative manufacturing equipment for production of the seal parts.

### DETAILED DESCRIPTION OF THE DISCLOSURE

Aspects of the disclosure relate to polymeric security seal parts having anti-microbial properties, and to the production of such seal parts. Such seal parts may constitute a one-piece plastic seal. Such seal parts may be at least part of a security seal. Such seal parts may be part of a high security seal also featuring a more durable substance than plastic. Such more durable substance may be steel. The steel may be in the form of a steel bolt or a steel cable securely joined at one or both ends to an end containing a polymeric seal part. (Production of anti-microbial plastic coatings of the durable substance of high security seals is herein anticipated.)

An anti-microbial polymeric seal part according to the invention may be produced by molding into an appropriate configuration, a formulation that includes a base resin and a quantity of anti-microbial metal ion. The appropriate configuration may include zip-tie-like configurations. The appropriate configuration may include snap-top band configurations. The appropriate configuration may include padlock-like configurations. The appropriate configuration may include bands configured to be joined with more durable seal parts such as metal bolts or cables to produce high security seals.

The base resin may be a resin that includes polyethylene. The polyethylene may include high density polyethylene. The base resin may be a resin that includes polypropylene. The polypropylene may include high density polypropylene. The base resin may be a resin that includes nylon. The base resin may be a resin that includes any other polymer suited for manufacturing by molding. The base resin may be a resin that includes any other polymer suited for processing by injection molding after the resin is mixed with the quantity of anti-microbial metal ion to produce a moldable formulation. The base resin may be a resin that includes any other polymer suited for the handling and wear to which a security seal may be subjected during use. The base resin may include more than one type of and density of polymeric plastic.

The anti-microbial metal ion may be an ion of a metal or metalloid of Groups 13-16 of the Periodic Table of Elements. The metal ion may be an ion of a transition metal of the d-block of the Periodic Table of Elements. The metal ion may include Ag¹⁺. The metal ion may include Cu²⁺. The metal ion may include Zn²⁺. The metal ion may include any other metal ions with demonstrated anti-microbial properties. The metal ion may include any other metal ions with demonstrated microbicidal properties. The metal ion may include any metal ions that are microbicidal at concentrations at which they are featured in the seal parts produced by methods of the invention.

The anti-microbial properties may include virus-inhibiting properties. The anti-microbial properties may include virus-suppressing properties. The anti-microbial properties may include virucidal properties. The anti-microbial properties may include bacteria-inhibiting properties. The anti-microbial properties may include bacteria-suppressing properties. The anti-microbial properties may include bactericidal properties. The anti-microbial properties may include anti-biofilm properties. The anti-microbial properties may include fungi-inhibiting properties. The anti-microbial properties may include fungi-suppressing properties. The anti-microbial properties may include fungicidal properties. The anti-microbial properties may include protozoa-inhibiting properties. The anti-microbial properties may include protozoa-suppressing properties. The anti-microbial properties may include protozoicidal properties.

The anti-microbial properties of the seal part may be tuned to meet or exceed those needed for specific applications. Thus, as examples, a higher concentration than usual of microbicidal metal ions and/or a selection of more potently microbicidal metal ions than usual may be used in a production runs of seals parts to be used in hospital settings, for use in geographic areas with known endemic microbe-borne illnesses, and/or for use during a pandemic.

The microbicidal properties of the seal part may confer some anti-microbial properties to hands, gloves and other objects contacting the seal part, particularly together with water (such as sweat), for some time after contact, by loss of seal-surface metal ions to the contacting water.

The anti-microbial metal ion may be mixed with the base resin. The anti-microbial metal ion, in being mixed with the base resin, may be introduced on a carrier substance. The carrier substance may include glass. The carrier substance may include plastic. The carrier substance may be in the form of particles. The carrier substance may be in the form of granules. The carrier substance may be in the form of pellets. The metal ion may be distributed upon an exterior of the carrier substance. The metal ion may coat the carrier substance. The metal ion may be distributed throughout an interior of the carrier substance. The metal ion may be encapsulated within the carrier substance.

The quantity of metal ion mixed with the base resin may be, in terms of the volume of carrier to the volume of the formulation of base resin plus carrier, in a range of about 1% to about 12%. The quantity of metal ion mixed with the base resin may be, in terms of the volume of carrier to the volume of the formulation of base resin plus carrier, in the range of about 3% to about 6%.

Colorant may be mixed into the formulation to produce seal parts of a given color. The carrier substance, with its metal ions, may be mixed into the colorant. The colorant, with or without the carrier, may be mixed with the base resin. The carrier substance, with its metal ions, may be mixed directly with the base resin.

The quantity of metal ion (and carrier substance) mixed with the base resin (and colorant) may be in a range producing a formulation that is moldable. The quantity of metal ion (and carrier substance) mixed with the base resin (and colorant) may be in a range producing a formulation that is processable by injection molding.

The quantity of metal ion (and carrier substance) mixed with the base resin (and colorant) may be set and/or controlled so that processing of the resulting formulation is not compromised. The quantity of metal ion (and carrier substance) mixed with the base resin (and colorant) may be set and/or controlled so that requirements of plastic properties of the resulting formulation as needed for molding are met or exceeded. The quantity of metal ion (and carrier substance) mixed with the base resin (and colorant) may be set and/or controlled so that requirements of plastic properties of the resulting formulation as needed for injection molding are met or exceeded.

The quantity of metal ion (and carrier substance) mixed with the base resin (and colorant) may be set and/or controlled so that properties of the anti-microbial polymeric seal part(s) produced from the resulting formulation are not compromised. The quantity of metal ion (and carrier substance) mixed with the base resin (and colorant) may be set and/or controlled so that requirements of mechanical properties of the anti-microbial polymeric seal part(s) produced from the resulting formulation are met or exceeded. The quantity of metal ion (and carrier substance) mixed with the base resin (and colorant) may be set and/or controlled so that requirements of usage properties of the anti-microbial polymeric seal part(s) produced from the resulting formulation are met or exceeded.

The quantity of metal ion (and carrier substance) mixed with the base resin (and colorant) may be in a range producing a formulation in which the metal ion is substantially distributed throughout the formulation. The quantity of metal ion (and carrier substance) mixed with the base resin (and colorant) may be in a range producing a formulation in which the metal ion is distributed substantially evenly throughout the formulation. The quantity of metal ion (and carrier substance) mixed with the base resin (and colorant) may be in a range producing a formulation that is microbicidal. The quantity of metal ion (and carrier substance) mixed with the base resin (and colorant) may be in a range producing a formulation that is microbicidal throughout the bulk of the formulation. The quantity of metal ion (and carrier substance) mixed with the base resin (and colorant) may be in a range producing a formulation that, when molded into the seal part, yields the anti-microbial seal part. The quantity of metal ion (and carrier substance) mixed with the base resin (and colorant) may be in a range producing a formulation that, when molded into the seal part, yields the anti-microbial seal part with microbicidal properties on surfaces of the seal part. The quantity of metal ion (and carrier substance) mixed with the base resin (and colorant) may be in a range producing a formulation that, when molded into the seal part, yields the anti-microbial seal part with microbicidal properties substantially throughout the body of the seal part. Thus, regions of the anti-microbial seal that may be exposed upon breaking the seal, may exhibit microbicidal properties.

Markings may be added to surfaces of the seal parts. The markings may be end-use-specific, such as, for example, word-stamps stating: “inspected by ______ as of ______” for fire extinguishers; “stocked/ready as of ______” for hospital crash carts; and “protected’ for generic shipping purposes. Markings may also include logos or custom artwork for promotional or authentication purposes.

A quantity of one or more than one additive that enhances the ability of the seal parts to accept markings may be mixed with the quantity of base resin (and colorant) and the quantity of metal ion (and carrier substance). The quantity of the additive(s) may be set and/or controlled so that properties of the anti-microbial polymeric seal part(s) produced from the resulting formulation are not compromised. Such additive(s) may enhance seal parts' acceptance of laser markings.

Identifying information can be added to surfaces of the seal parts. The identifying information may include, for example, unique alphanumeric sequences or numerical bar-codes. The identifying information may include, for example, seal-manufacturing history-containing QR codes. Unique numerical or other identification on individual seal parts may provide for lot tracking or auditable verification of secure/safe transfer of items in enclosures sealed by such seal parts. Other forms of identification may be included in the seal parts, such as embedded-radio frequency identification (rf-ID) chips. Embedded chips may be used for monitoring and/or tracking locations of the seals.

Methods for production of the anti-microbial seal parts may involve extrusion equipment and processes. Methods for production of the anti-microbial seal parts may involve molding equipment and processes. Methods for production of the anti-microbial seal parts may involve injection molding equipment and processes. Methods for production of the anti-microbial seal parts may involve any equipment and processes capable of producing polymeric plastic seal parts in accordance with the principles of the invention.

According to an illustrative presentation of the methods:
A) The quantity of metal ions may be added to the base resin. The quantity of metal ions may be added to the base resin, in and/or on the carrier substance.
B) The quantity of metal ions may be added to the colorant. The quantity of metal ions may be added to the colorant, in and/or on the carrier substance. The colorant plus carrier substance may be added to the base resin.
C) The quantity of metal ions may be split between direct addition to the base resin and direct addition to the colorant.
D) The formulation of the base resin plus the added ion-bearing carrier substance (plus the added colorant) may be mixed and fed into a heating unit for plasticization (melting). The heating unit may contain a (heated) turning auger or other mechanism that mixes and advances the bulk of the formulation forward within a barrel to a feed throat of a mold. Mechanical shear forces experienced by the advancing bulk of the formulation as it is worked within the barrel may contribute to the melting.
E) The mold may receive a preset amount of a forward-most section of the advancing mixed and plasticized formulation. A forward stroke of an injection unit, such as a ram-driven mechanical member or other means of effecting such forward movement, may completely push the preset amount into the mold and prevent its backwards motion as the mold pressurizes the preset amount into a pre-selected shape of one or more seal parts as determined by the mold's cavity configuration.
F) Pressure of the mold on the one or more seal parts contained in the mold cavity may be maintained as the mold and its contents cool down. Afterwards, the mold may be opened and the one or more seal parts may be released (ejected), to go on to surface-marking (by stamping and/or laser inscription) for branding and identification purposes, and then on to inspection and packaging.
G) To continue the seal part production process and proceed on to the next cycle of the production run, the opened mold may be closed and the molding process may be repeated: The now-closed mold may receive another preset amount of the advancing mixed and plasticized formulation from the heating unit, and progress through another cycle of the production run. The production run may continue producing the sets of the one or more seal parts with each cycle, until depletion of the formulation and/or of its components of base resin and ion-bearing carrier substance (and colorant).

Control and regulation of process-step details may be overseen throughout production of the seal parts. For instance, the quantities of base resin, metal ion, carrier and colorant may separately or together be tuned to requirements of a particular product run. The rates of feeding, mixing, melting, working and advancing of those quantities from entry into the barrel; through transit within the barrel; and on to entry into the mold, may be regulated to avoid overworking the melted material and to yield homogeneous dispersion of metal ion in smooth-edged seal parts. Adjustment of auger resistance to back-pressure during the melt's entry into and pressurizing within the mold may be attended to, with an aim of limiting seal part imperfections. Also toward that end, pressure and temperature regulation, including rate of cooling, of seal parts within the mold may be optimized before opening the mold and releasing the seal parts. As known to those skilled in the arts of polymer processing/extrusion/molding, such control and regulation may optimally be customized to a particular configuration of processing equipment, typically by an iterative, experience-informed approach.

Apparatus and methods described herein are illustrative.

Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

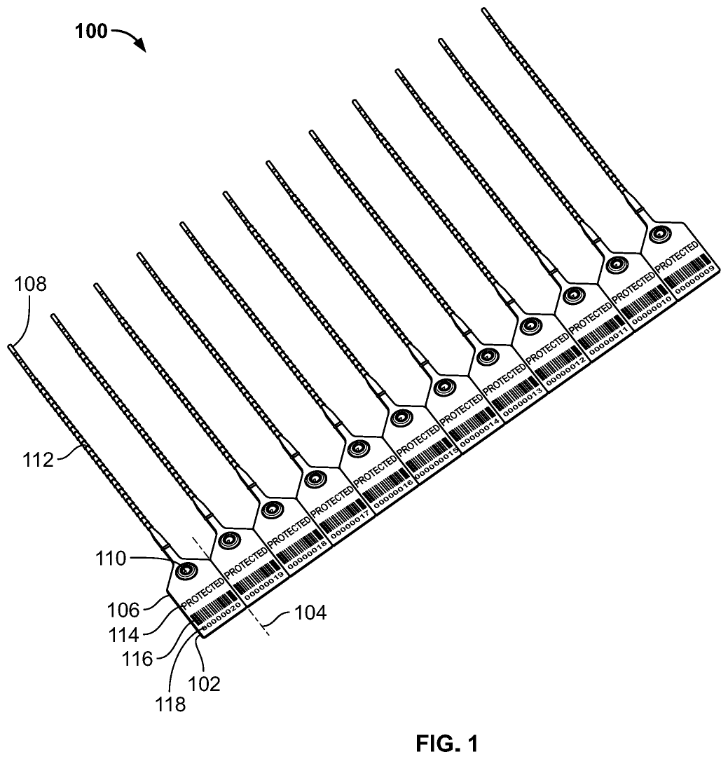

FIG. 1 shows set 100 of zip-tie-like anti-microbial polymeric seal parts as they may appear after completion of a production cycle, such as by injection molding followed by surface marking. Set 100 contains an illustrative dozen individual anti-microbial polymeric seal parts, each structurally substantially equivalent to individual anti-microbial polymeric seal part 102. Individual anti-microbial polymeric seal part 102 is configured to be separated from the rest of the set via flexing along scoring 104 molded into the set between head 106 of individual anti-microbial polymeric seal part 102 and the head of the adjacent individual anti-microbial polymeric seal part of set 100.

Individual anti-microbial polymeric seal part 102, as illustrative of any of the individual anti-microbial polymeric seal parts of set 100, features tapered narrow-diameter tail 108. Tail 108 is intended, in applying individual anti-microbial polymeric seal part 102 (after its separation from the rest of set 100) to effect security sealing of an enclosure (not shown), to be looped around and/or through closure components (not shown) of the enclosure, back toward head 106. Tail 108 is then inserted through receiving aperture 110 located on head 106. Subsequently, tail 108 is further advanced through aperture 110, allowing strap 112 to be pulled through the aperture and tightened about the closure components. Such zip-tie-like anti-microbial polymeric seal parts provide a variable-length security seal with microbicidal properties. (As illustrative exemplars of zip-tie-like anti-microbial polymeric seal parts, the individual anti-microbial polymeric seal parts of set 100 should be understood to represent anti-microbial polymeric seal parts featuring proportions of head, strap and tail different from those depicted, to accommodate enclosures of numerous sizes and sealing requirements.)

Individual anti-microbial polymeric seal part 102 features surface markings. The surface markings include end-use-specific wording 114, in this case stating “PROTECTED.” The surface markings include numeric information in the form of identifying bar-code 116. The surface markings include numeric information in the form of identifying numeric string 118.

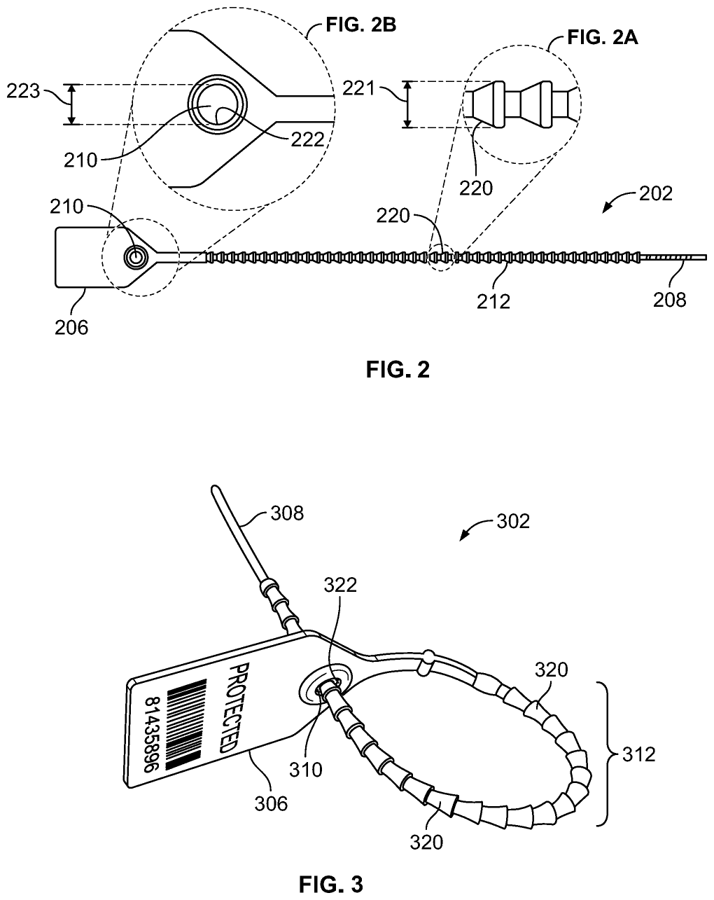

FIG. 2 shows individual anti-microbial polymeric seal part 202. Individual anti-microbial polymeric seal part 202 may have features in common with individual anti-microbial polymeric seal part 102 (shown in FIG. 1). Individual anti-microbial polymeric seal part 202 may have features with functions in common with those of features of individual anti-microbial polymeric seal part 102.

Individual anti-microbial polymeric seal part 202 features head 206, tail 208, aperture 210 and strap 212. Along strap 212, individual anti-microbial polymeric seal part 202 has a series of linearly nested frustoconical features 220. As shown in magnified inset FIG. 2A of representative features 220, each feature 220 has a largest outer diameter 221. Along strap 212, outer diameter 221 is the largest transverse cross-sectional diameter. As shown in magnified inset FIG. 2B of aperture 210, aperture 210 is bounded by inner rim 222 with inner diameter 223. Outer diameter 221 is larger than inner diameter 223.

Pulling strap 212 through aperture 210 by, and toward, tail 208 (as illustrated as if in arrested motion in FIG. 3) is readily achieved—despite tight tolerances by which outer diameter 221 is larger than inner diameter 223—because of inherent flexibility of the mechanically interacting polymer cone surfaces and the polymer-rimmed aperture surface. Such pulling motion is uni-directional, exhibiting a ratcheting effect that geometrically and mechanically precludes reversing the direction of motion of strap 212 once feature 220's outer diameter 221 has passed through rim 222. (As an illustrative exemplar of zip-tie-like anti-microbial polymeric seal parts, individual anti-microbial polymeric seal part 202 should be understood to represent anti-microbial polymeric seal parts featuring complementary shapes of aperture inner surfaces and strap outer-most cross-sectional structures different from those depicted, to produce the uni-directional ratcheting effect by interaction of those different geometric and mechanical features. Such other zip-tie-like anti-microbial polymeric seal parts may include those with flat straps, saw-tooth stepped ratchet features and a complementary rectangular aperture into which a tail could be inserted and drawn forward, as known and practiced in the art.)

FIG. 3 shows individual anti-microbial polymeric seal part 302. Individual anti-microbial polymeric seal part 302 may have features in common with individual anti-microbial polymeric seal part 102 (shown in FIG. 1). Individual anti-microbial polymeric seal part 302 may have features with functions in common with those of features of individual anti-microbial polymeric seal part 102. Individual anti-microbial polymeric seal part 302 may have features in common with individual anti-microbial polymeric seal part 202 (shown in FIG. 2). Individual anti-microbial polymeric seal part 302 may have features with functions in common with those of features of individual anti-microbial polymeric seal part 202.

Individual anti-microbial polymeric seal part 302 features head 306, tail 308, aperture 310, strap 312, frustoconical features 320 and inner rim 322. Individual anti-microbial polymeric seal part 302 is shown looped on and through itself, as it might appear applied to an enclosure (enclosure is not shown), with strap 312 having been pulled partly through aperture 310 by, and toward, tail 308. Geometric and mechanical interaction of rim 322 with a frustoconical feature 320 at its widest transverse cross-sectional diameter precludes removal of strap 312 from head 306 by pulling strap 312 opposite to the direction of tail 308, thus providing for secure tamper-evident sealing of the enclosure.

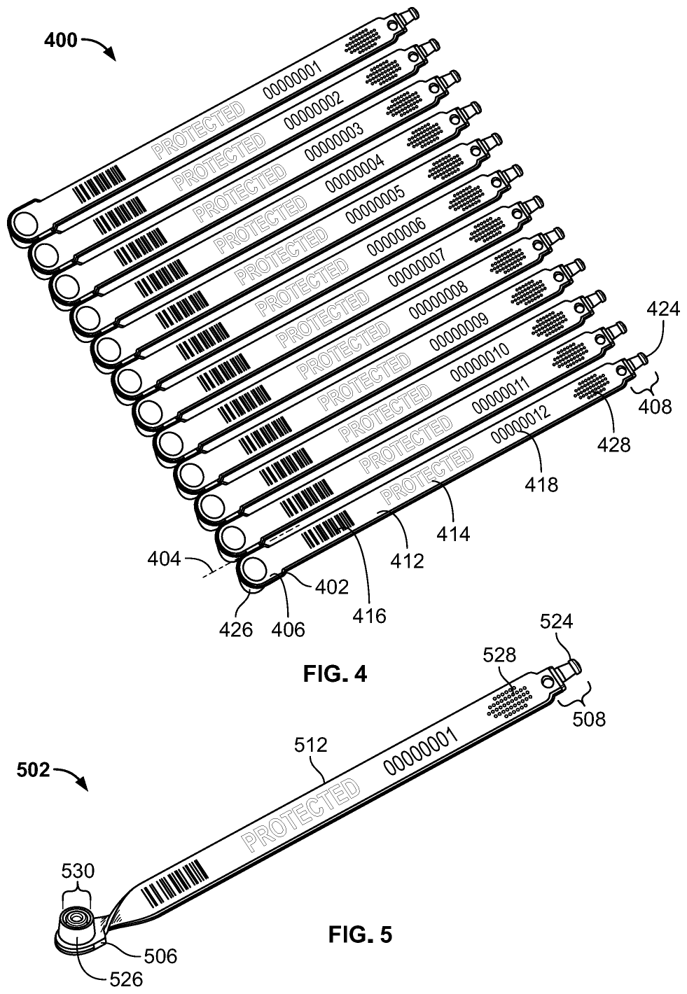

FIG. 4 shows set 400 of snap-top-band-like anti-microbial polymeric seal parts as they may appear after completion of a production cycle, such as by injection molding followed by surface marking. Set 400 contains an illustrative dozen individual anti-microbial polymeric seal parts, each structurally substantially equivalent to individual anti-microbial polymeric seal part 402. Individual anti-microbial polymeric seal part 402 is configured to be separated from the rest of the set via flexing along scoring 404 molded into the set between head 406 of individual anti-microbial polymeric seal part 402 and the head of the adjacent individual anti-microbial polymeric seal part of set 400.

Individual anti-microbial polymeric seal part 402, as illustrative of any of the individual anti-microbial polymeric seal parts of set 400, features tail 408 terminating in snap-top stud 424. Tail 408 is intended, in applying individual anti-microbial polymeric seal part 402 (after its separation from the rest of set 400) to effect security sealing of an enclosure (not shown), to be looped around and/or through closure components (not shown) of the enclosure, back toward head 406. Snap-top stud 424 is then inserted into a snap-top receiving socket (shown in FIG. 5), socket cup 426 of which extends (as depicted, into the plane of the paper) perpendicular to the plane of strap 412. Such snap-top-like anti-microbial polymeric seal parts provide a fixed-length security seal with microbicidal properties, the fixed-length set mainly by the length of strap 412. (As illustrative exemplars of a snap-top-like anti-microbial polymeric seal parts, the individual anti-microbial polymeric seal parts of set 400 should be understood to represent anti-microbial polymeric seal parts featuring proportions of head, strap and tail different from those depicted, to accommodate enclosures of numerous sizes and sealing requirements.)

Individual anti-microbial polymeric seal part 402 features surface markings. The surface markings include end-use-specific wording 414, in this case stating “PROTECTED.” The surface markings include numeric information in the form of identifying bar-code 416. The surface markings include numeric information in the form of identifying numeric string 418. The surface markings may also include logos or custom artwork (not shown). Such logos or custom artwork may be directed to promotional purposes. Such logos or custom artwork may be directed to other purposes. Such other purposes may include authentication purposes. Individual anti-microbial polymeric seal part 402 features grip surface 428.

FIG. 5 shows individual anti-microbial polymeric seal part 502. Individual anti-microbial polymeric seal part 502 may have features in common with individual anti-microbial polymeric seal part 402 (shown in FIG. 4). Individual anti-microbial polymeric seal part 502 may have features with functions in common with those of features of individual anti-microbial polymeric seal part 402.

Individual anti-microbial polymeric seal part 502 features head 506, tail 508 terminating in snap-top stud 524, strap 512 and socket cup 526. On strap 512, close to tail 508, individual anti-microbial polymeric seal part 502 features grip surface 528. Grip surface 528 is intended to facilitate irreversible insertion of snap-top stud 524 into snap-top socket 530 within socket cup 526. (Individual anti-microbial polymeric seal part 502 is depicted with a twist along strap 512 so as to show interior aspects of features of snap-top socket 530 within socket cup 526.) Snap-top socket 530 features interior surfaces generally complementary to and accepting of exterior surfaces of snap-top stud 524. The complementary surfaces of snap-top stud 524 and of snap-top socket 530 are set to close tolerances to allow for (generally forceful) insertion of snap-top stud 524 into snap-top socket 530, and also to preclude removal of snap-top stud 524, once fully inserted, from snap-top socket 530.

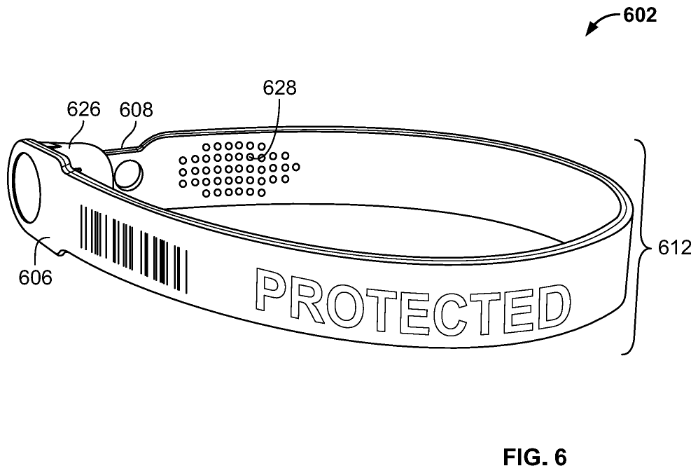

FIG. 6 shows individual anti-microbial polymeric seal part 602. Individual anti-microbial polymeric seal part 602 may have features in common with individual anti-microbial polymeric seal part 402 (shown in FIG. 4). Individual anti-microbial polymeric seal part 602 may have features with functions in common with those of features of individual anti-microbial polymeric seal part 402. Individual anti-microbial polymeric seal part 602 may have features in common with individual anti-microbial polymeric seal part 502 (shown in FIG. 5). Individual anti-microbial polymeric seal part 602 may have features with functions in common with those of features of individual anti-microbial polymeric seal part 502.

FIG. 6 shows individual anti-microbial polymeric seal part 602 features: head 606, tail 608, strap 612, socket cup 626 and grip surface 628 (with interior aspects of individual anti-microbial polymeric seal part 602's snap-top socket and exterior aspects of its snap-top stud not showing). Individual anti-microbial polymeric seal part 602 is shown looped on itself, as it might appear applied to an enclosure (enclosure is not shown), with tail 608 irreversibly engaged with socket cup 626 (by means of mechanical interactions of interior aspects of individual anti-microbial polymeric seal part 602's snap-top socket within socket cup 626 and exterior aspects of individual anti-microbial polymeric seal part 602's snap-top stud at the end of tail 608). Geometric and mechanical interaction of the snap-top features of individual anti-microbial polymeric seal part 602 thus provide for secure tamper-evident sealing of the enclosure.

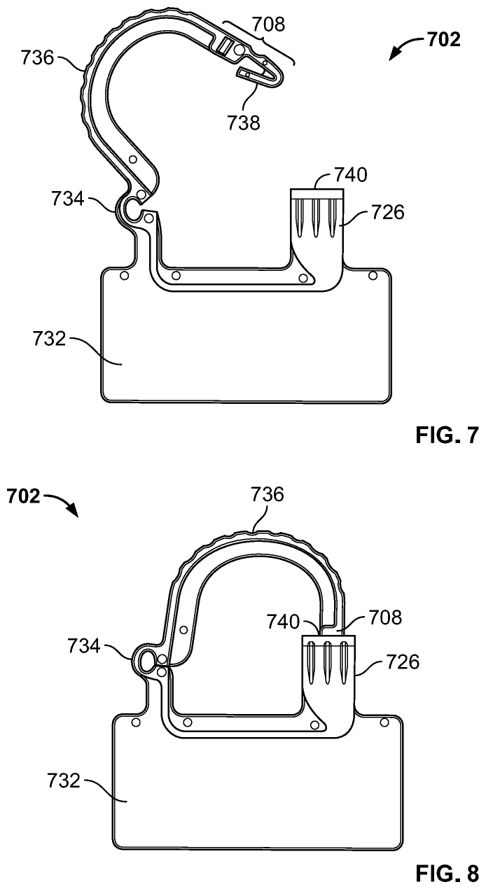

FIG. 7 shows padlock-like anti-microbial polymeric seal part 702 as it may appear after completion of a production cycle, such as by injection molding (and, if produced as a set of a plurality of scored-between padlock-like anti-microbial polymeric seal parts (not shown), then also after separation from the rest of the set). Padlock-like anti-microbial polymeric seal parts may be molded to be less flexible overall than zip-tie-like anti-microbial polymeric seal parts (shown in FIGS. 1-3). Padlock-like anti-microbial polymeric seal parts may be molded to be less flexible overall than snap-top-band-like anti-microbial polymeric seal parts (shown in FIGS. 4-6).

Padlock-like anti-microbial polymeric seal part 702 features padlock body 732, flexible hinge 734 and shackle 736 that terminates at head 708. Head 708 bears at its terminus fishhook clasp 738. Flexible hinge 734 and fishhook clasp 738 may be among the most flexible structural features of padlock-like anti-microbial polymeric seal part 702. Shackle 736 is intended, in applying individual anti-microbial polymeric seal part 702 to effect security sealing of an enclosure (not shown), to be moved over and/or through closure components (not shown) of the enclosure, and then flexed via hinge 734 toward and into socket cup 726. Socket cup 726 features internal clasp-receiving-and-locking feature 740 (details not visible in depiction).

Internal clasp-receiving-and-locking feature 740 may include a bar (not shown) that irreversibly snags fishhook clasp 738 upon its insertion into and seating within socket cup 726. Internal clasp-receiving-and-locking feature 740 may include an internal annular ridge (not shown) that fishhook clasp 738 passes by flexion during insertion into socket cup 726, but that blocks removal of fishhook clasp 738 from socket cup 726 once fishhook clasp 738 is seated unflexed within socket cup 726. Internal clasp-receiving-and-locking feature 740 may feature additional or alternative internal structures for allowing insertion into socket cup 726 of head 708 with its fishhook clasp 738 and preventing their removal from socket cup 726, as known and practiced in the art.

FIG. 8 shows padlock-like anti-microbial polymeric seal part 702 as it might appear applied to an enclosure (enclosure is not shown), with head 708 of shackle 736 fully and irreversibly engaged within internal clasp-receiving-and-locking feature 740 within socket cup 726. Opening the sealed enclosure entails breaking padlock-like anti-microbial polymeric seal part 702. Geometric and mechanical interaction of the padlock features of anti-microbial polymeric seal part 702 thus provide for secure tamper-evident sealing of the enclosure.

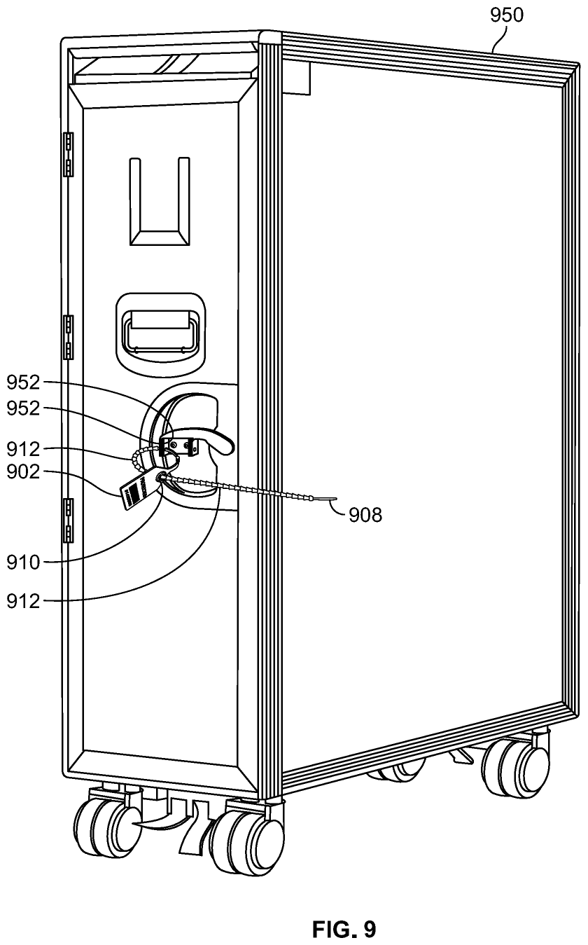

FIG. 9 shows zip-tie-like anti-microbial polymeric seal part 902. Anti-microbial polymeric seal part 902 may have features in common with individual anti-microbial polymeric seal part 102 (shown in FIG. 1). Anti-microbial polymeric seal part 902 may have features with functions in common with those of features of individual anti-microbial polymeric seal part 102. Anti-microbial polymeric seal part 902 may have features in common with individual anti-microbial polymeric seal part 202 (shown in FIG. 2). Anti-microbial polymeric seal part 902 may have features with functions in common with those of features of individual anti-microbial polymeric seal part 202. Anti-microbial polymeric seal part 902 may have features in common with individual anti-microbial polymeric seal part 302 (shown in FIG. 3). Anti-microbial polymeric seal part 902 may have features with functions in common with those of features of individual anti-microbial polymeric seal part 302.

FIG. 9 shows zip-tie-like anti-microbial polymeric seal part 902 as it may appear applied to effect security sealing of enclosure 950. Strap 912 of anti-microbial polymeric seal part 902 is shown having been looped around and/or through closure components 952 of enclosure 950; and then uni-directionally and irreversibly pulled through aperture 910 of anti-microbial polymeric seal part 902 in the direction of tail 908 to securely seal enclosure 950.

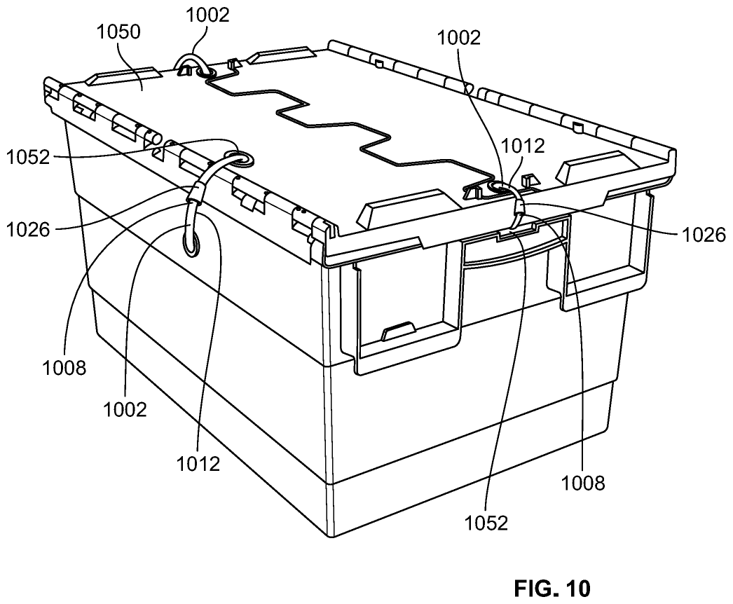

FIG. 10 shows several snap-top-band-like anti-microbial polymeric seal parts 1002. Anti-microbial polymeric seal parts 1002 may have features in common with individual anti-microbial polymeric seal part 402 (shown in FIG. 4). Anti-microbial polymeric seal parts 1002 may have features with functions in common with those of features of individual anti-microbial polymeric seal part 402. Anti-microbial polymeric seal parts 1002 may have features in common with individual anti-microbial polymeric seal part 502 (shown in FIG. 5). Anti-microbial polymeric seal parts 1002 may have features with functions in common with those of features of individual anti-microbial polymeric seal part 502. Anti-microbial polymeric seal parts 1002 may have features in common with individual anti-microbial polymeric seal part 602 (shown in FIG. 6). Anti-microbial polymeric seal parts 1002 may have features with functions in common with those of features of individual anti-microbial polymeric seal part 602.

FIG. 10 shows snap-top-band-like anti-microbial polymeric seal parts 1002 as they may appear applied to effect security sealing of enclosure 1050. Strap 1012 of an anti-microbial polymeric seal part 1002 is shown having been looped around and/or through closure components 1052 of enclosure 1050; and then tail 1008 was irreversibly snapped into socket cup 1026 of the anti-microbial polymeric seal part 1002 to securely seal enclosure 1050.

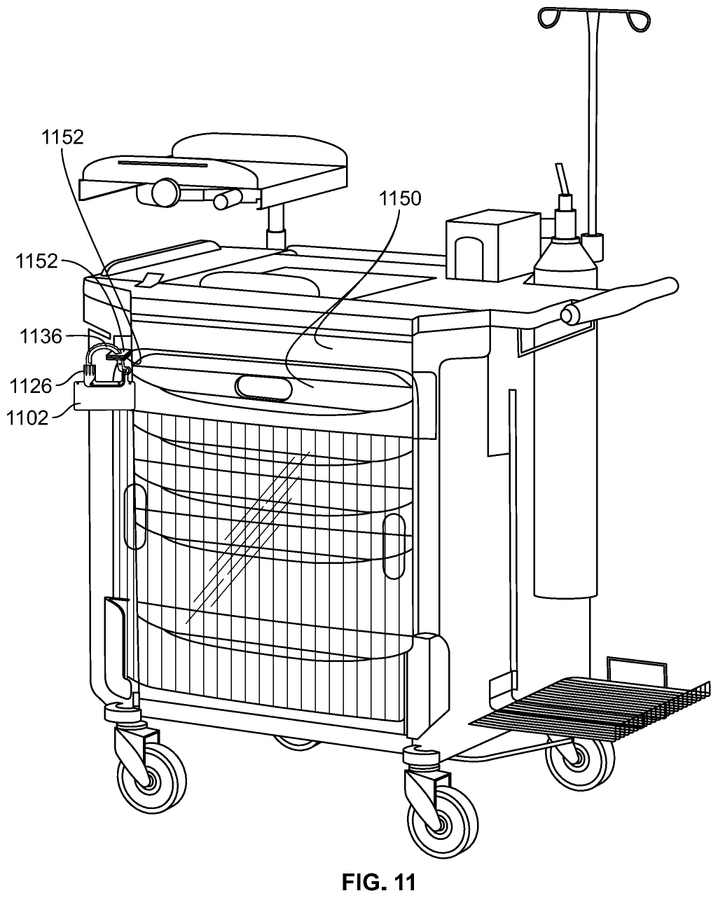

FIG. 11 shows padlock-like anti-microbial polymeric seal part 1102. Anti-microbial polymeric seal part 1102 may have features in common with anti-microbial polymeric seal part 702 (shown in FIGS. 7 and 8). Anti-microbial polymeric seal part 1102 may have features with functions in common with those of features of individual anti-microbial polymeric seal part 702.

FIG. 11 shows padlock-like anti-microbial polymeric seal part 1102 as it may appear applied to effect security sealing of enclosure 1150. Shackle 1136 of anti-microbial polymeric seal part 1102 is shown having been moved over and/or through closure components 1152 of enclosure 1150; and then irreversibly inserted into and seated within socket cup 1126 of anti-microbial polymeric seal part 1102 to securely seal enclosure 1150.

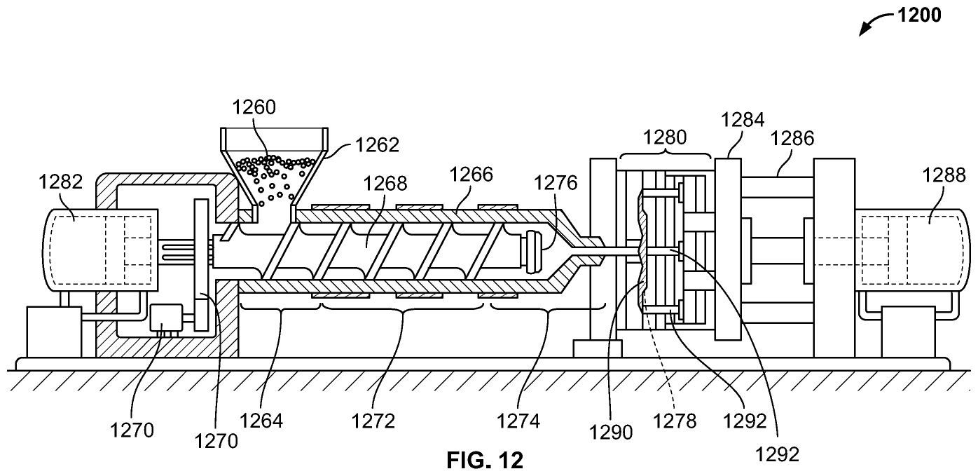

FIG. 12 shows in schematic form injection molding equipment 1200 that may be used for the production of anti-microbial polymeric seal parts. (Anticipated herein is utilization of any equipment and processing capable of producing polymeric plastic seal parts in accordance with the principles of the invention.) Material 1260 may include the base resin and the quantity of microbicidal metal ion (typically on/in the carrier substance), with or without colorant. Material 1260 is shown disposed within hopper 1262 from which material 1260 is fed into material feed zone 1264 of heated barrel 1266. (Material 1260 in hopper 1262 may include all the material components of the formulation for anti-microbial polymeric seal parts. Alternatively, some of the material components of the formulation may bypass hopper 1262 and be fed directly into feed zone 1264 in conjunction with the feeding of material in hopper 1262, so as to together constitute material 1260.)

Running longitudinally through barrel 1266 is rotating/reciprocating auger 1268. Rotation of auger 1268 is driven by drive mechanism 1270.

Rotation of auger 1268 mixes material 1260 in feed zone 1264. Rotation of auger 1268 advances material 1260 from feed zone 1264 to melting/plasticization zone 1272. Rotation of auger 1268 continues to mix melted material 1260. Rotation of auger 1268 advances melted material 1260 to material metering zone 1274. In material metering zone 1274, mixed and melted material 1260 is driven by rotation of auger 1268 to a region between no-return barrier 1276 and mold cavity 1278 of closed mold 1280; at which point in the process, auger reciprocation cylinder 1282 drives auger 1268 longitudinally in the direction of advancement of melted material 1260. Auger 1268's final forward-driven position (not shown) abuts no-return barrier 1276 against internal forward walls of barrel 1266.

The longitudinal motion of auger 1268 forces melted material 1260 into mold cavity 1278, injecting mixed and melted material 1260 into and filling cavity 1278. Pressure is maintained on mold 1280 by movable platen 1284 having been driven toward mold 1280 along tie rods 1286 by mold clamping cylinder 1288 at the start of the production cycle to close mold 1280. Injected material 1260 is prevented by forward-driven no-return barrier 1276 (forward-driven position of barrier 1276 not shown) from flowing backwards out of mold cavity 1278 until injected material 1260 cools sufficiently to set into mold shape 1290 of the anti-microbial polymeric seal part(s) of the production cycle.

With sufficient setting of molded material 1260 within mold 1280 into mold shape 1290 (substantially complementary to mold cavity 1278), pressure is relieved from mold 1280; mold 1280 is opened (not shown) with movement of platen 1284 along tie rods 1286 back toward clamping cylinder 1288. Mold ejection fingers 1292 may facilitate removal of molded shape 1290 from opened mold 1280. (Auger 1268 may be moved back longitudinally in the direction away from mold 1280 and mold 1280 may be reclosed in preparation for the next production cycle.)

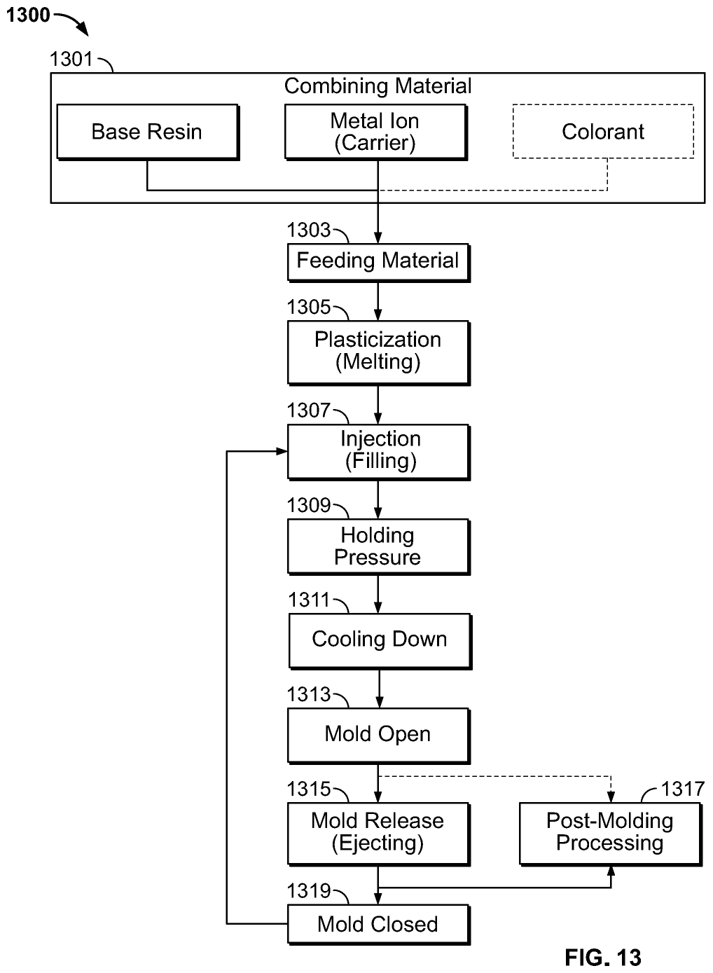

FIG. 13 shows illustrative steps of injection molding process 1300 for production of anti-microbial polymeric seal parts. (Anticipated herein is utilization of any equipment and processing capable of producing polymeric plastic seal parts in accordance with the principles of the invention.) Control and regulation of steps of process 1300 may be overseen, monitored, set and/or adjusted throughout the production of the seal parts.

Process 1300 may begin with step 1301, in which the quantity of microbicidal metal ion (typically via the carrier substance) is added to the base resin (with or without colorant) as a material-combining initial processing step that combines material components of the anti-microbial formulation.

Process 1300 may continue with step 1303. At step 1303, step 1301's combined material is fed into downstream processing equipment. Step 1303 may include mixing that contributes to producing a homogeneously mixed formulation. Step 1303 may include initial heating of the mixed combined material. Step 1303 may include transfer of the material further downstream within the processing equipment.

Process 1300 may continue with step 1305. At step 1305, step 1303's mixed combined material is heated so as to melt/plasticize it. Step 1305 may include further mixing, contributing to producing a homogeneously mixed and moldable formulation. Step 1305 may include transfer of the homogeneously mixed and melted material further downstream within the processing equipment.

Process 1300 may continue with step 1307. At step 1307, step 1305's homogeneously mixed and moldable formulation material is injected into a closed mold, filling the mold with hot material that occupies a mold cavity complementary to a desired shape of anti-microbial polymeric seal parts.

Process 1300 may continue with step 1309. At step 1309, step 1307's hot injected material is held under pressure within the mold.

Process 1300 may continue with step 1311. At step 1311, step 1309's hot injected material within the mold cools, setting into the shape of the mold cavity.

Process 1300 may continue with step 1313. At step 1313, the mold is opened once step 1311's material has cooled and set sufficiently to maintain the shape molded into it by the mold cavity.

Process 1300 may continue with step 1315. At step 1315, step 1313's cooled and shape-set molded anti-microbial polymeric seal parts are released/ejected from the open mold.

Process 1300 may continue with step 1317. At step 1317, step 1315's released/ejected molded anti-microbial polymeric seal parts may undergo post-molding processing, such as surface marking. (Alternatively and/or additionally, post-molding processing step 1317 or, at least, preparatory stages of post-molding processing may be executed before step 1315.) Post-molding processing 1317 may include mold trimming, product inspection and/or packaging

Process 1300 may be readied at step 1319 for a subsequent cycle of production of anti-microbial polymeric seal parts. In step 1319, the mold emptied in step 1315 is closed to re-establish the mold cavity into which the subsequent production cycle's homogeneously mixed and moldable formulation material may be injected, indicated by process step 1319's return branch to step 1307.

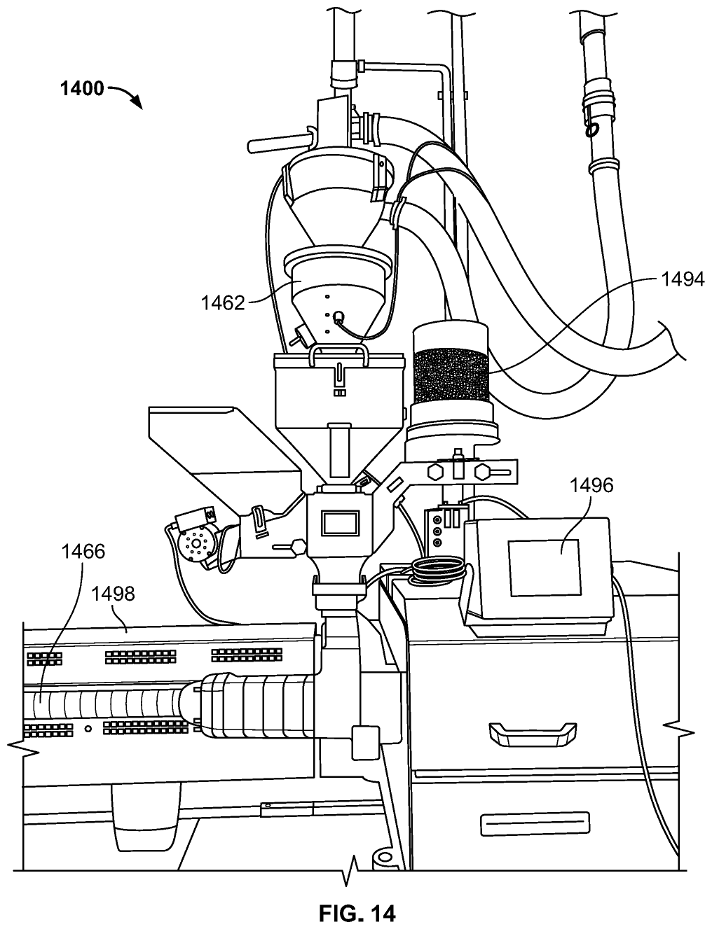

FIG. 14 presents a view of equipment 1400 that may be utilized to produce anti-microbial polymeric seal parts. Equipment 1400 may have features in common with schematized injection molding equipment 1200 (shown in FIG. 12). Equipment 1400 may have features with functions in common with those of features of schematized injection molding equipment 1200. Equipment 1400 may have features with functions that are congruent to process steps of process 1300 (shown in FIG. 13). Equipment 1400 may be configured to carry out processing steps that are congruent to process steps of process 1300.

Equipment 1400 may feature material hopper 1462. Hopper 1462 may contain one or more material components of the formulation for anti-microbial polymeric seal parts. The material components in hopper 1462 may include an amount of the base resin. The material components in hopper 1462 may include a portion of the quantity of anti-microbial metal ions needed to constitute the formulation for anti-microbial polymeric seal parts. The material components in hopper 1462 may include the carrier substance of hopper 1462's portion of the quantity of anti-microbial metal ion. The material components in hopper 1462 may be fed into downstream processing sections of equipment 1400.

Additive holder 1494 may contain no, one or more than one additional material components of the formulation. Such additional material component(s) may include a portion of the quantity of anti-microbial metal ions needed to constitute the formulation for anti-microbial polymeric seal parts. Such additional material component(s) may include the carrier substance of additive holder 1494's portion of the quantity of anti-microbial metal ion. Such additional material component(s) may include colorant. Such additional material component(s) may include one or more than one additive that enhances seal parts' ability to accept markings, including laser markings. Such additional material component(s) may include an additional amount of base resin. Such additional material component(s) may include an amount of polymer resin different from that in hopper 1462. Material components in additive holder 1494 may be fed into the downstream processing sections of equipment 1400.

Combined and mixed material components from material hopper 1462 and additive container 1494 may, together, constitute the formulation to be molded into anti-microbial polymeric seal parts.

Equipment 1400 may feature process-controlling/monitoring console 1496. Process-controlling/monitoring console 1496 may be configured to monitor and/or control one or more process steps of production of anti-microbial polymeric seal parts.

Equipment 1400 may feature sector 1498. Sector 1498 may house at least some of equipment 1400's processing sections for production of anti-microbial polymeric seal parts, which sections are disposed downstream from material hopper 1462 and additive container 1494. Sector 1498 may house barrel 1466 through which the formulation is advanced toward a mold (not shown).

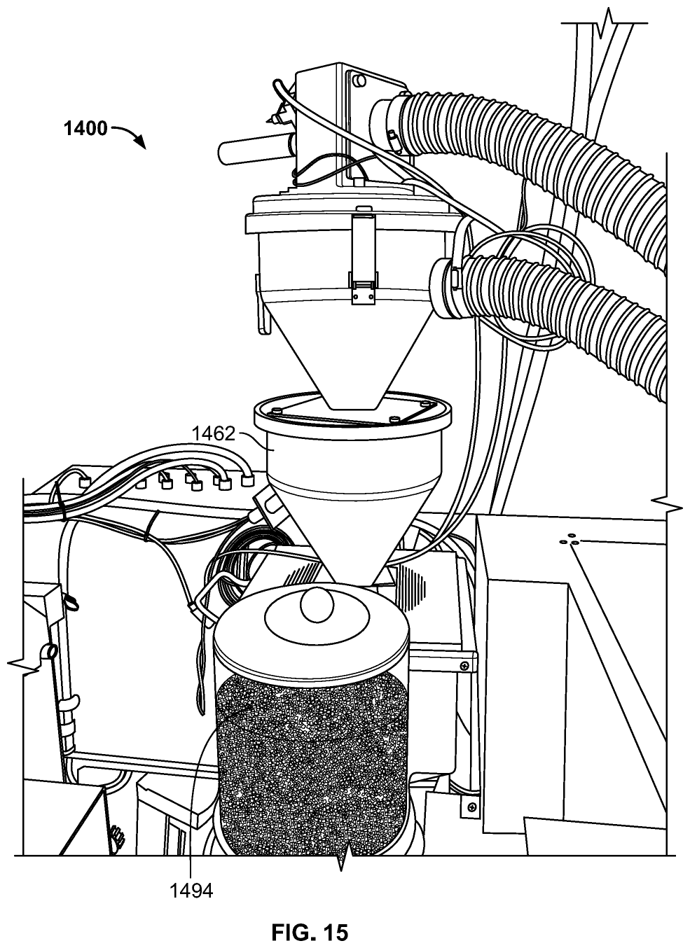

FIG. 15 presents another view of equipment 1400, showing material hopper 1462 and additive container 1494.

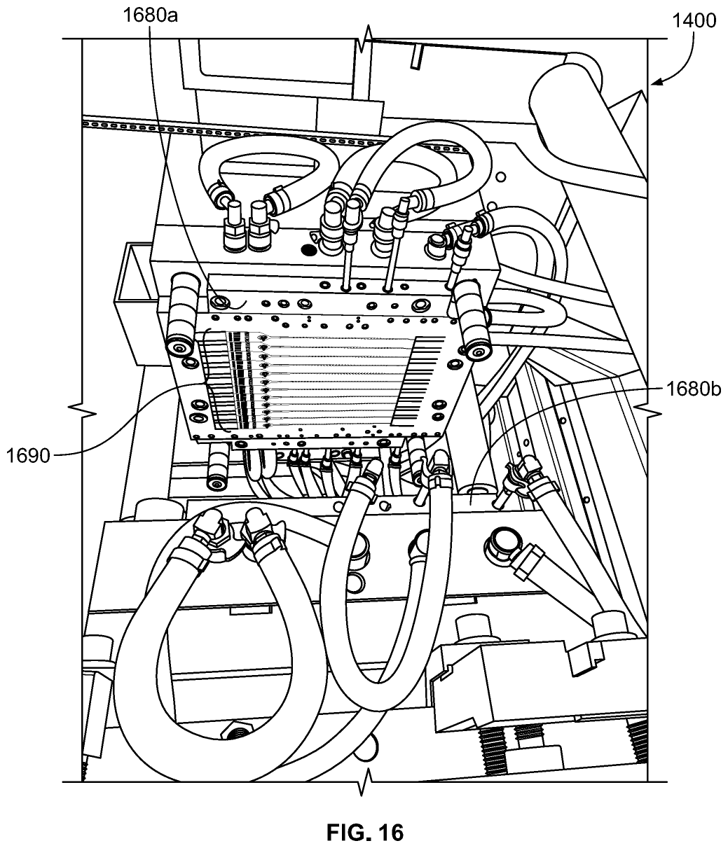

FIG. 16 presents yet another view of equipment 1400, showing two facing sides, 1680a and 1680b, of equipment 1400's injection mold. FIG. 16 shows that mold open, as it would be toward the end of a production cycle (see, e.g., steps 1313 and 1317, shown in FIG. 13), revealing molded shape 1690 of the anti-microbial polymeric seal parts of the production cycle. Molded shape 1690 of the anti-microbial polymeric seal parts of the production cycle, may have features and functions in common with set 100 of zip-tie-like anti-microbial polymeric seal parts (shown in FIG. 1).

It should be noted that the foregoing shows and/or describes exemplary embodiments of apparatus, products, systems and methods according to the invention.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined.

Apparatus and systems may omit features shown and/or described in connection with illustrative apparatus. Embodiments may include features that are neither shown nor described in connection with the illustrative apparatus and/or systems. Features of illustrative apparatus and/or systems may be combined. For example, an illustrative embodiment may include features shown in connection with another illustrative embodiment.

The drawings show illustrative features of apparatus, products, systems and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems, apparatus and methods for using and producing anti-microbial polymeric security seal parts are provided. Persons skilled in the art will appreciate that the present invention can be practiced by other than the described embodiments, which are presented for purposes of illustration rather than of limitation. The present invention is limited only by the claims that follow.

What is claimed is:

1) An anti-microbial polymeric seal part comprising:
a moldable formulation including a base resin and a quantity of anti-microbial metal ion,
wherein the seal part is molded from the formulation.

2) The seal part of claim 1 wherein the seal part is at least part of a security seal.

3) The seal part of claim 1 wherein the base resin includes polyethylene.

4) The seal part of claim 1 wherein the base resin includes polypropylene.

5) The seal part of claim 1 wherein the base resin includes nylon.

6) The seal part of claim 1 wherein the metal ion is distributed substantially homogeneously throughout the seal part.

7) The seal part of claim 1 wherein the metal ion is present throughout the seal part in microbicidal concentration.

8) The seal part of claim 1 wherein, in production of the formulation, the metal ion is added to the base resin via a carrier substance.

9) The seal part of claim 8 wherein the quantity, in terms of carrier to carrier plus base resin, is in the range of about 1% to about 12% V/V.

10) The seal part of claim 9 wherein the quantity, in terms of carrier to carrier plus base resin, is in the range of about 3% to about 6% V/V.

11) The seal part of claim 1 wherein the metal ion is Ag¹⁺.

12) The seal part of claim 1 wherein the metal ion is Cu²⁺.

13) The seal part of claim 1 further comprising a colorant additive.

14) The seal part of claim 1 further comprising an additive that enhances the ability of the seal part to accept laser marking.

15) A method of producing an anti-microbial plastic seal part, the method comprising the steps of:
adding a quantity of anti-microbial metal ion to a base resin;
mixing the quantity of the anti-microbial metal ion with the base resin resulting in a mixed formulation; and
molding the mixed formulation into a shape of the plastic seal part.

16) The method of claim 15 further comprising adding colorant to the base resin.

17) The method of claim 16 wherein the adding the quantity is adding at least part of the quantity to the colorant.

18) The method of claim 15 wherein the base resin includes polyethylene.

19) The method of claim 15 wherein the base resin includes polypropylene.

20) The method of claim 15 wherein the base resin includes nylon.

21) The method of claim 15 wherein the metal ion is Ag¹⁺.

22) The method of claim 15 wherein is the metal ion Cu²⁺.

23) The method of claim 15 wherein, in the adding, the metal ion is added to the base resin via a carrier substance.

24) The method of claim 23 wherein the quantity, in terms of carrier to carrier plus base resin, is in the range of about 1% to 12% V/V.

25) The method of claim 24 wherein the quantity, in terms of carrier to carrier plus base resin, is in the range of about 3% to about 6% V/V.

26) The method of claim 15 wherein the mixing distributes the metal ion substantially homogeneously throughout the mixed formulation.

27) The method of claim 15 further comprising heating the mixed formulation thereby plasticizing the formulation.

28) The method of claim 15 further comprising cooling the plasticized mixed formulation upon it being molded into the shape.

29) The method of claim 15 wherein the molding is injection molding.
